(19) United States
(12) Patent Application Publication
(10) Pub. No.: US 2026/0329121 A1
(43) Pub. Date: Oct. 22, 2026

(54) DISPLAY DEVICE

(71) Applicant: Shanghai Tianma Micro-Electronics Co., Ltd., Shanghai (CN)

(72) Inventors: Yoko TAKAMADATE, Kawasaki (JP); Futoshi NAKANISHI, Kawasaki (JP); Hitoshi YOSHIDA, Kawasaki (JP); Akira BANJOUYA, Kawasaki (JP); Noriyuki ITOU, Kawasaki (JP); Akira SUZUKI, Kawasaki (JP); Koetsu ISHIKAWA, Kawasaki (JP)

(73) Assignee: Shanghai Tianma Micro-Electronics Co., Ltd., Shanghai (CN)

(21) Appl. No.: 19/644,102

(22) Filed: Apr. 10, 2026

(30) Foreign Application Priority Data
Apr. 17, 2025 (JP) 2025-068175

(51) Int. Cl. G02F 1/1333

(52) U.S. Cl. CPC G02F 1/133331

(57) ABSTRACT

A display device includes a display, a cover, a decorative member, and a light shield. The display displays a screen element. The cover is disposed on a display surface side of the display. The decorative member is provided on a main surface side of the cover, and includes a display region and a non-display region. The decorative member has a pattern extending in a predetermined direction. The light shield is disposed between the display and the decorative member, and overlaps the non-display region when viewed from above. The light shield includes a serrated configuration at an end portion located on the display region side when viewed from above. At least a portion of the serrated configuration overlaps the display region when viewed from above. A direction in which a tip portion of the serrated configuration extends is parallel to a direction in which the pattern extends.

### CROSS-REFERENCE TO RELATED APPLICATIONS

This application claims the benefit of Japanese Patent Application No. 2025-068175, filed on Apr. 17, 2025, the entire disclosure of which is incorporated by reference herein.

### FIELD OF THE INVENTION

The present disclosure relates generally to a display device.

### BACKGROUND OF THE INVENTION

In the related art, display devices are known in which a light-transmitting decorative member is disposed on a display surface side of a display panel to improve design. In the display panel on which the decorative member is disposed, a boundary between a display region that displays characters, images, and other information, and a frame region surrounding the display region may be noticeable.

Accordingly, in order to make a boundary between a display surface and an outer frame of a display device less noticeable while no image is displayed, Japanese Patent Application Publication No. 2020-034773 discloses a display device with a transmittance adjustment sheet that includes a display device, a transmittance adjustment sheet, and a decorative sheet. The transmittance adjustment sheet is disposed facing the display device, and has a transparent portion and a colored portion including a gradient portion adjacent to the transparent portion. The gradient portion faces at least partially the display surface of the display device. In the gradient portion, a visible light transmittance decreases as distance from the transparent portion increases.

In Japanese Patent Application Publication No. 2020-034773, the gradient portion is superimposed on the boundary between the display surface and the outer frame of the display device, thereby making the boundary less noticeable while no image is displayed. However, in the display device with the transmittance adjustment sheet disclosed in Japanese Patent Application Publication No. 2020-034773, when the decorative sheet has a high transmittance, the gradient portion itself is visually recognized by a user, and the design of the display device may be thus impaired.

### SUMMARY OF THE INVENTION

In order to achieve the above objective, a display device of the present disclosure includes:
a display to display a screen element;
a cover disposed on a display surface side of the display and having a light-transmitting property;
a decorative member provided on a main surface of the cover, including a display region in which the screen element is transparently displayed and a non-display region adjacent to the display region, and having a pattern extending in a predetermined direction; and
a light shield disposed between the display and the decorative member and overlapping the non-display region when viewed from above, wherein
the light shield includes a serrated configuration at an end portion located on the display region side when viewed from above,
at least a portion of the serrated configuration overlaps the display region when viewed from above, and
a direction in which a tip portion of the serrated configuration extends is parallel to a direction in which the pattern extends.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a plan view illustrating a display device according to Embodiment 1;

FIG. 2 is a cross-sectional view of the display device illustrated in FIG. 1, taken along line A-A;

FIG. 3 is a plan view illustrating a liquid crystal display panel according to Embodiment 1;

FIG. 4 is a plan view illustrating a decorative layer according to Embodiment 1;

FIG. 5 is a plan view illustrating a light shield according to Embodiment 1

FIG. 6 is a schematic view illustrating a serrated configuration of the light shield, and a display region and a non-display region of a decorative member, according to Embodiment 1;

FIG. 7 is a plan view illustrating the serrated configuration according to Embodiment 1

FIG. 8 is a diagram illustrating results of subjective evaluation according to Embodiment 1;

FIG. 9 is a diagram illustrating results of subjective evaluation according to Embodiment 1;

FIG. 10 is a cross-sectional view illustrating a display device according to Embodiment 2;

FIG. 11 is a schematic view illustrating a serrated configuration of a light shield, and a display region and a non-display region of a decorative member, according to Embodiment 3;

FIG. 12 is a plan view illustrating a tip portion of the serrated configuration according to Embodiment 3;

FIG. 13 is a schematic view illustrating the serrated configuration of the light shield, and the display region and the non-display region of the decorative member, according to Embodiment 3;

FIG. 14 is a plan view illustrating the tip portion of the serrated configuration according to Embodiment 3;

FIG. 15 is a plan view illustrating a tip portion of a serrated configuration according to a modified example;

FIG. 16 is a plan view illustrating a tip portion of a serrated configuration according to a modified example; and

FIG. 17 is a schematic view illustrating a serrated configuration of a light shield, and a display region and a non-display region of a decorative member, according to a modified example.

### DETAILED DESCRIPTION OF THE INVENTION

A display device according to various embodiments is described below with reference to the drawings.

### Embodiment 1

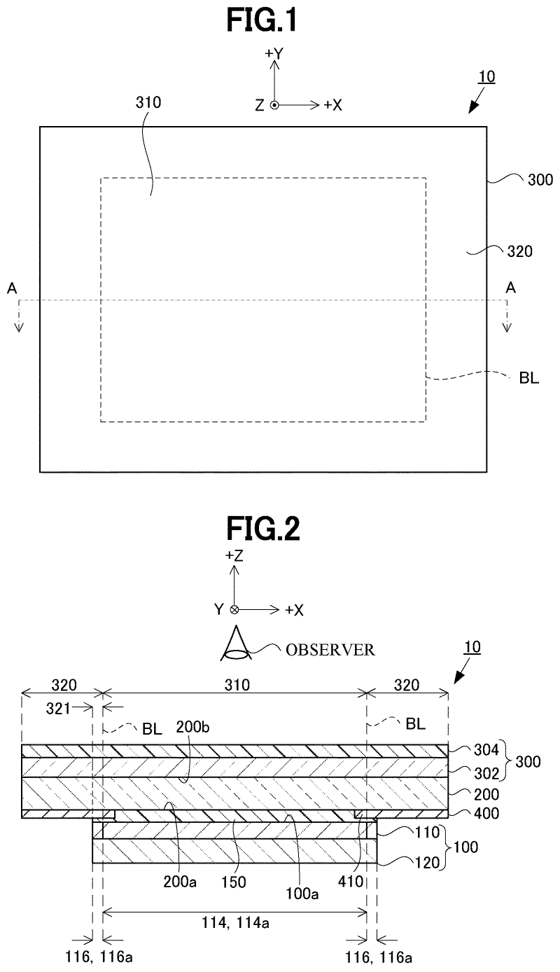

A display device 10 according to the present embodiment is described with reference to FIGS. 1 to 9. As illustrated in FIGS. 1 and 2, the display device 10 includes a display 100, a cover 200, a decorative member 300, and a light shield 400. The display 100 includes a displayable region 114 and a frame region 116, and displays screen elements (that is, characters, images, and other information) in the displayable region 114. The cover 200 protects the display 100. The decorative member 300 allows the screen elements displayed on the display 100 to be transmitted, and provides an observer with a design of the decorative member 300 when no screen elements are displayed on the display 100. The light shield 400 overlaps the frame region 116 of the display 100, and hides the frame region 116. The light shield 400 makes a boundary BL between a display region 310 and a non-display region 320 of the decorative member 300 (described later) less visible. 10 The display device 10 is installed on a dashboard of a car, furniture, a home appliance, or the like. In the present description, to facilitate comprehension, in the display device 10 of FIG. 1, the longitudinal right direction (the right direction on paper) is referred to as the “+X direction”, the short direction (the up direction on paper) is referred to as the “+Y direction”, and the direction perpendicular to the +X direction and the +Y direction (the front direction on paper) is referred to as the “+Z direction”.

The display 100 of the display device 10 is a transmissive liquid crystal display device that displays the screen elements. In a non-display state in which no screen elements are displayed, the displayable region 114 of the display 100 is black.

As illustrated in FIG. 2, the display 100 is adhered to the cover 200 and the light shield 400 via a light-transmitting adhesive layer 150. In one example, the adhesive layer 150 is formed from an optical clear adhesive (OCA). The display 100 includes a liquid crystal display panel 110 and a back light 120.

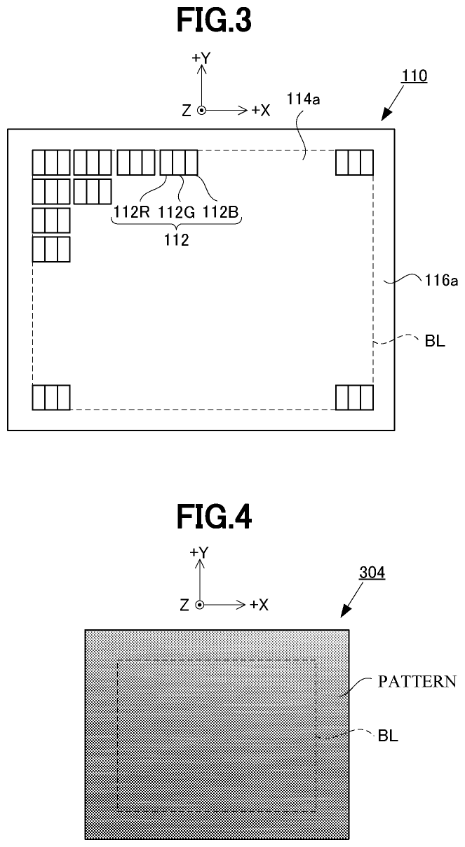

In one example, the liquid crystal display panel 110 of the display 100 is a horizontal electric field type liquid crystal display panel that is active matrix driven by thin film transistors (TFT). The liquid crystal display panel 110 displays the screen elements. As illustrated in FIG. 3, the liquid crystal display panel 110 includes a displayable region 114a where main pixels 112 are arranged in a matrix, and a frame region 116a that surrounds the displayable region 114a and where wiring, a driver circuit, and the like are disposed. Each of the main pixels 112 is formed from a red pixel 112R that emits red light, a green pixel 112G that emits green light, and a blue pixel 112B that emits blue light. The displayable region 114a of the liquid crystal display panel 110 corresponds to the displayable region 114 of the display 100, and the frame region 116a of the liquid crystal display panel 110 corresponds to the frame region 116 of the display 100.

The displayable region 114a is a region where the screen elements (characters, images, and other information) can be displayed, while the frame region 116a is a region where characters, images, and other information cannot be displayed. The displayable region 114a corresponds to the display region 310 of the decorative member 300, and the frame region 116a corresponds to the non-display region 320 of the decorative member 300.

As illustrated in FIG. 2, the back light 120 of the display 100 is disposed on a back surface side (the-Z side) of the liquid crystal display panel 110. In one example, the back light 120 is implemented as a direct back light. The back light 120 includes a white light emitting diode (LED) element, a reflective sheet, a diffusion sheet, a lighting circuit, and the like (all not illustrated in the drawings). In the present embodiment, the back light 120 emits light of a uniform luminance on the liquid crystal display panel 110.

The cover 200 of the display device 10 has a light-transmitting property, and protects the display 100. The cover 200 is disposed on a display surface 100a side (the +Z side) of the display 100. The cover 200 has an outer shape larger than that of the liquid crystal display panel 110, and covers the liquid crystal display panel 110. The cover 200 includes a first main surface 200a on the display 100 side (the −Z side) and a second main surface 200b opposite to the first main surface 200a. The first main surface 200a of the cover 200 is adhered to the display surface 100a of the display 100 via the adhesive layer 150. The second main surface 200b of the cover 200 is provided with the decorative member 300. The cover 200 is a glass substrate, a plastic substrate, or the like.

The decorative member 300 of the display device 10 has a light-transmitting property, and allows the screen elements displayed on the display 100 to be transmitted. The decorative member 300 is a member that provides an observer with a design. The decorative member 300 is provided on the second main surface 200b of the cover 200 via a non-illustrated light-Transmitting adhesive.

The decorative member 300 includes the display region 310 and the non-display region 320. The display region 310 corresponds to the displayable region 114 of the display 100 (the displayable region 114a of the liquid crystal display panel 110). The non-display region 320 is located outside the display region 310, and is adjacent to the display region 310. The non-display region 320 includes a region 321 that corresponds to the frame region 116 of the display 100 (the frame region 116a of the liquid crystal display panel 110), and is a region where the screen elements are not displayed. The display region 310 of the decorative member 300 corresponds to a display region of the display device 10, and the non-display region 320 of the decorative member 300 corresponds to a non-display region of the display device 10.

The decorative member 300 includes a light-transmitting film 302 and a decorative layer 304. The light-transmitting film 302 is adhered to the second main surface 200b of the cover 200. In one example, the light-transmitting film 302 is formed from a light-transmitting synthetic resin.

The decorative layer 304 is a layer that provides an observer with a design. In one example, the decorative layer 304 is formed by printing a pattern in a desired color on the light-transmitting film 302. Here, the pattern of the decorative layer 304 of the present description is a pattern extending in a predetermined direction (that is, one direction). In one example, the pattern of the decorative layer 304 is a linear pattern, such as a woodgrain pattern, a hairline pattern, or a striped pattern, extending in the predetermined direction. In the present embodiment, the predetermined direction is the X direction. Hereinafter, the pattern of the decorative layer 304 is a hairline pattern extending in the predetermined direction (the X direction) as illustrated in FIG. 4.

The light shield 400 of the display device 10 is disposed between the display 100 and the decorative member 300. In the present embodiment, as illustrated in FIG. 2, the light shield 400 is disposed on the first main surface 200a of the cover 200. The light shield 400 has a frame shape, overlaps the frame region 116a of the liquid crystal display panel 110 (the frame region 116 of the display 100) when viewed from above, and hides the frame region 116a of the liquid crystal display panel 110. The light shield 400 also overlaps the non-display region 320 of the decorative member 300 when viewed from above (observer side). The light shield 400 is black and, for example, is printed on the first main surface 200a of the cover 200 using a black ink.

In the present embodiment, the black light shield 400 overlaps the non-display region 320 of the decorative member 300 corresponding to the frame region 116 of the display 100 when viewed from above. Therefore, when an observer visually observes the non-display region 320 of the decorative member 300 in the non-display state (a state in which the display device 10 is not displaying characters, images, or other information), a black-based hairline pattern is observed.

The displayable region 114 of the display 100 in the non-display state is black. The display region 310 of the decorative member 300 corresponds to the displayable region 114 of the display 100. Therefore, even when an observer visually observes the display region 310 of the decorative member 300 in the non-display state, the black-based hairline pattern is observed.

When an observer visually observes the display device 10 in the non-display state, both the display region 310 and the non-display region 320 of the decorative member 300 appear as the black-based hairline pattern. However, when there is a color difference between the black color of the displayable region 114 of the display 100 and the black color of the light shield 400, the boundary BL between the display region 310 and the non-display region 320 of the decorative member 300 may be noticeable.

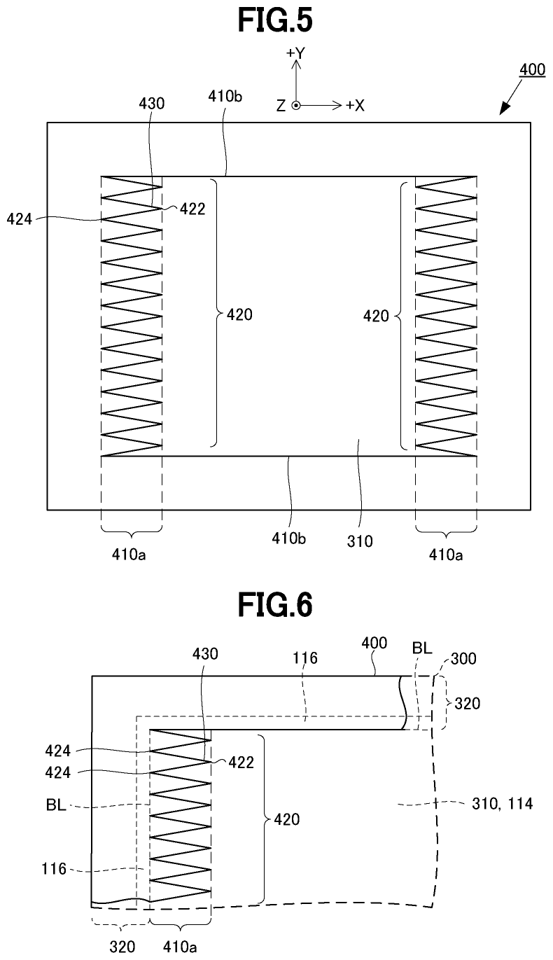

As illustrated in FIGS. 5 and 6, the light shield 400 includes serrated configurations 420 at end portions 410a located on the display region 310 side of the decorative member 300 when viewed from above. At least a portion of each of the serrated configurations 420 overlaps the display region 310 when viewed from above. In the present embodiment, the entirety of the serrated configurations 420 overlaps the display region 310 when viewed from above. Each of the serrated configurations 420 includes tips 422 and roots 424, and tip portions 430 defined by the tips 422 and the roots 424. In order to facilitate comprehension, the decorative member 300 is illustrated by a dashed line in FIG. 6.

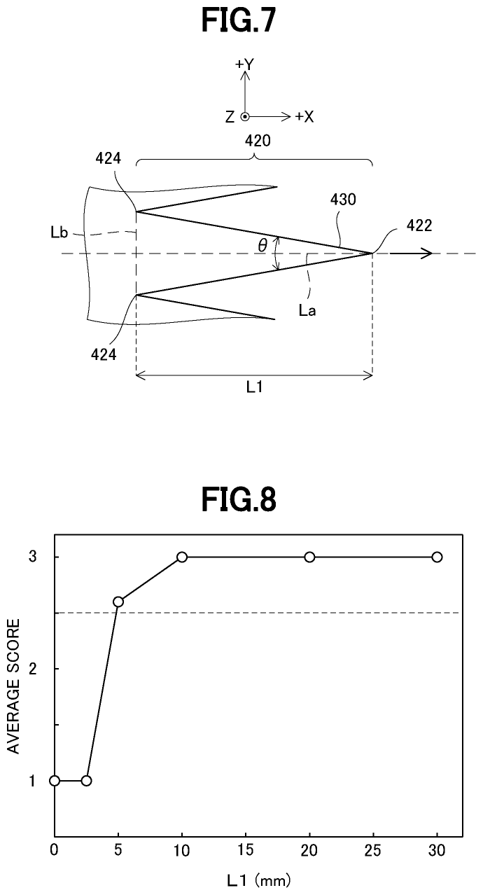

As illustrated in FIG. 7, the tip portion 430 of the serrated configuration 420 extends in a direction (the X direction) parallel to the direction (the X direction) in which the pattern of the decorative layer 304 (the decorative member 300) extends. When a triangle (the tip portion 430) is defined by one tip 422 and two roots 424 adjacent to the one tip 422 in the serrated configuration 420, the pattern of the decorative layer 304 intersects a line segment Lb connecting the two roots 424. Therefore, the direction in which the tip portion 430 extends being parallel to the direction in which the pattern of the decorative layer 304 extends means that a straight line La extending from the one tip 422 in parallel with the pattern of the decorative layer 304 intersects the line segment Lb connecting the two adjacent roots 424.

The tip portion 430 of the serrated configuration 420 extends in the direction (the X direction) parallel to the direction (the X direction) in which the pattern of the decorative layer 304 extends. Therefore, the light shield 400 is not provided with the serrated configurations 420 at end portions (for example, end portions 410b illustrated in FIG. 5) that are located on the display region 310 side of the decorative member 300 and extend in the direction (X direction) parallel to the direction in which the pattern of the decorative layer 304 extends.

The serrated configurations 420 have a size that allows an observer to visually observe the serrated shape. In one example, the serrated configurations 420 have a size that allows an observer to visually observe the serrated shape at an observation distance of 0.6 m. Therefore, the serrated configurations 420 do not have effects resulting from gradation such as the gradient portion disclosed in Japanese Patent Application Publication No. 2020-034773.

Specifically, as described later, a horizontal distance L1 in the direction (X direction) in which the pattern of the decorative layer 304 extends, between the root 424 and the tip 422 adjacent to the root 424 in the serrated configuration 420, is preferably 5 mm or greater and 40 mm or less (5 mm≤L1≤40 mm). Further, as described later, an angle θ of the tip portion 430 of the serrated configuration 420 is preferably 10° or greater and 25° or less (10°≤θ≤25°).

In the present embodiment, the serrated configurations 420 overlap the display region 310 of the decorative member 300 when viewed from above, and the tip portions 430 of the serrated configurations 420 extend in the direction parallel to the direction in which the pattern of the decorative layer 304 extends. Thus, when an observer views the display device 10 in the non-display state, the black color of the serrated configurations 420 (the light shield 400) appears blended with the black color of the displayable region 114 of the display 100 through the decorative member 300. This causes an optical illusion to occur in the observer and, even when there is a color difference between the black color of the light shield 400 and the black color of the displayable region 114, makes the boundary BL between the display region 310 and the non-display region 320 of the decorative member 300 less visible in the non-display state. In order to further make the boundary BL less visible, as illustrated in FIG. 6, the roots 424 of the serrated configuration 420 preferably overlap the boundary BL when viewed from above.

The light shield 400 is not provided with the serrated configurations 420 at the end portions 410b that are located on the display region 310 side of the decorative member 300 and extend in the direction parallel to the direction in which the pattern of the decorative layer 304 extends. However, the boundary BL extending in the direction parallel to the direction in which the pattern of the decorative layer 304 extends appears blended with the pattern of the decorative layer 304. Thus, even when the end portions 410b are not provided with the serrated configurations 420, the boundary BL extending in the direction parallel to the direction in which the pattern of the decorative layer 304 extends is less visible to an observer.

As described above, even when there is a color difference between the black color of the light shield 400 and the black color of the displayable region 114 of the display 100, the boundary BL between the display region 310 and the non-display region 320 of the decorative member 300 can be less visible in the non-display state. This facilitates management of a color difference between the black color of the light shield 400 and the black color of the displayable region 114, and also improves the yield of manufacturing of the display device 10. Since the boundary BL is made less visible by causing the black color of the light shield 400 to appear blended with the black color of the displayable region 114 without relying on gradation, there is little risk that the serrated configurations 420 become noticeable in the non-display state even when the decorative member 300 has a high transmittance. This allows the decorative member 300 having a high transmittance to be used in the display device 10, and reduces power consumption of the display 100 (the back light 120).

In the following description, the horizontal distance L1 in the X direction from the root 424 to the tip 422 in the serrated configuration 420, the angle θ of the tip portion 430, and the difficulty in visually recognizing the boundary BL are described.

Here, a plurality of observers observed the display device 10 in which the horizontal distance L1 and the angle θ of the tip portion 430 were varied, and evaluated the difficulty in visually recognizing the boundary BL using a three-level subjective evaluation. In the display device 10 used for the evaluation, a color difference ΔE* between the black color of the light shield 400 and the black color of the displayable region 114 was set to 5.3, and a lightness difference ΔL* was set to 5.1. The transmittance of the decorative member 300 was set to 50%. The observers observed the display device 10 at a position 0.6 m away from the display device 10. The observers evaluated the difficulty in visually recognizing the boundary BL in accordance with the evaluation criteria below.
3 points: The boundary BL is not visible.
2 points: The boundary BL is indistinctly visible.
1 point: The boundary BL is visible.

FIG. 8 illustrates results of the subjective evaluation for the display device 10 in which the angle θ of the tip portion 430 is set to 10° and the horizontal distance L1 is varied. When an average score of 2.5 or higher is regarded as indicating that the boundary BL is less visible, as illustrated in FIG. 8, the horizontal distance L1 is preferably 5 mm or greater (L1≥5 mm). Meanwhile, when the horizontal distance L1 is greater than 40 mm, the serrated configurations 420 are noticeably observable. Thus, the horizontal distance L1 is preferably 40 mm or less.

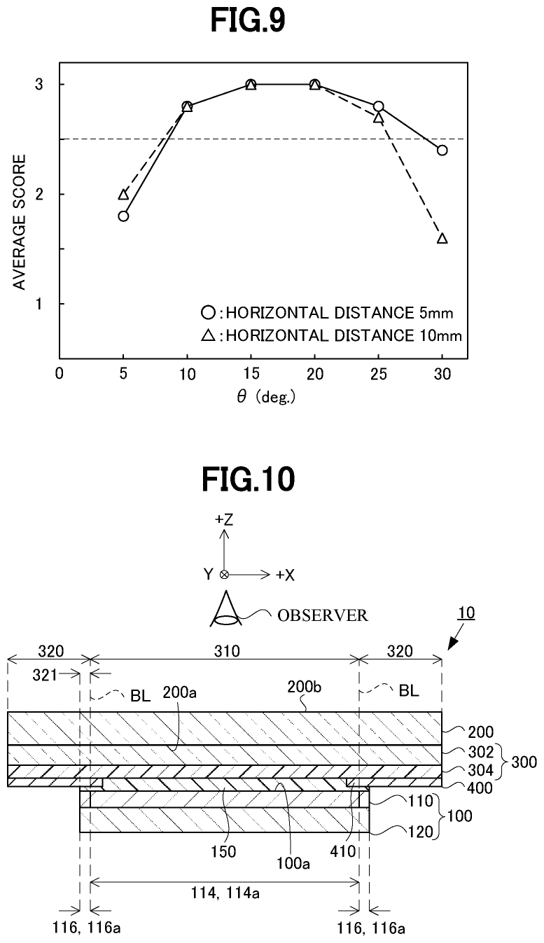

FIG. 9 illustrates results of the subjective evaluation for the display device 10 in which the horizontal distance L1 is set to 5 mm or 10 mm and the angle θ of the tip portion 430 is varied. When an average score of 2.5 or higher is regarded as indicating that the boundary BL is less visible, as illustrated in FIG. 9, the angle θ of the tip portion 430 is preferably 10° or greater and 25° or less (10°≤θ≤25°).

As described above, in the display device 10, the serrated configurations 420 at the end portions 410a of the light shield 400 overlap the display region 310 of the decorative member 300, and the tip portions 430 of the serrated configurations 420 extend in the direction parallel to the direction in which the pattern of the decorative layer 304 (the decorative member 300) extends. This allows, in the display device 10, the boundary BL between the display region 310 and the non-display region 320 of the decorative member 300 to be less visible in the non-display state.

### Embodiment 2

In Embodiment 1, the decorative member 300 is provided on the second main surface 200b of the cover 200. The light shield 400 is disposed on the first main surface 200a of the cover 200.

A configuration may be employed in which the decorative member 300 is provided on the first main surface 200a of the cover 200 and the light shield 400 is disposed on the decorative member 300.

As with the display device 10 of Embodiment 1, the display device 10 of the present embodiment includes the display 100, the cover 200, the decorative member 300, and the light shield 400. The configurations of the display device 10 of the present embodiment are the same as the configurations of the display device 10 of Embodiment 1, except for arrangement of the decorative member 300 and the light shield 400. Here, the arrangement of the decorative member 300 and the light shield 400 of the present embodiment is described.

In the present embodiment, as illustrated in FIG. 10, the decorative member 300 is provided on the first main surface 200a located on the display 100 side of the cover 200. In the present embodiment, the light-transmitting film 302 of the decorative member 300 is adhered to the first main surface 200a of the cover 200.

In the present embodiment, the light shield 400 is disposed on the decorative layer 304 of the decorative member 300. The light shield 400 may be disposed between the display 100 and the decorative member 300.

In the present embodiment, the display 100 is adhered to the decorative layer 304 and the light shield 400 via the light-transmitting adhesive layer 150.

As with the display device 10 of Embodiment 1, in the display device 10 of the present embodiment, the serrated configurations 420 at the end portions 410a of the light shield 400 overlap the display region 310 of the decorative member 300, and the tip portions 430 of the serrated configurations 420 extend in the direction parallel to the direction in which the pattern of the decorative layer 304 extends. Therefore, in the display device 10 of the present embodiment, the boundary BL between the display region 310 and the non-display region 320 of the decorative member 300 can be less visible in the non-display state.

### Embodiment 3

In Embodiments 1 and 2, the displayable region 114 of the display 100 and the display region 310 of the decorative member 300 have a rectangular shape. The displayable region 114 and the display region 310 may have any shape.

As with the display device 10 of Embodiment 1, the display device 10 of the present embodiment includes the display 100, the cover 200, the decorative member 300, and the light shield 400. In the present embodiment, the light shield 400 of the display device 10 is described using an example of the display device 10 in which the displayable region 114 of the display 100 and the display region 310 of the decorative member 300 have a circular shape (the boundary BL: circular). The other configurations of the display device 10 of the present embodiment are the same as the configurations of the display device 10 of Embodiment 1.

As with the light shield 400 of Embodiment 1, the light shield 400 of the present embodiment is black, and is disposed on the first main surface 200a of the cover 200.

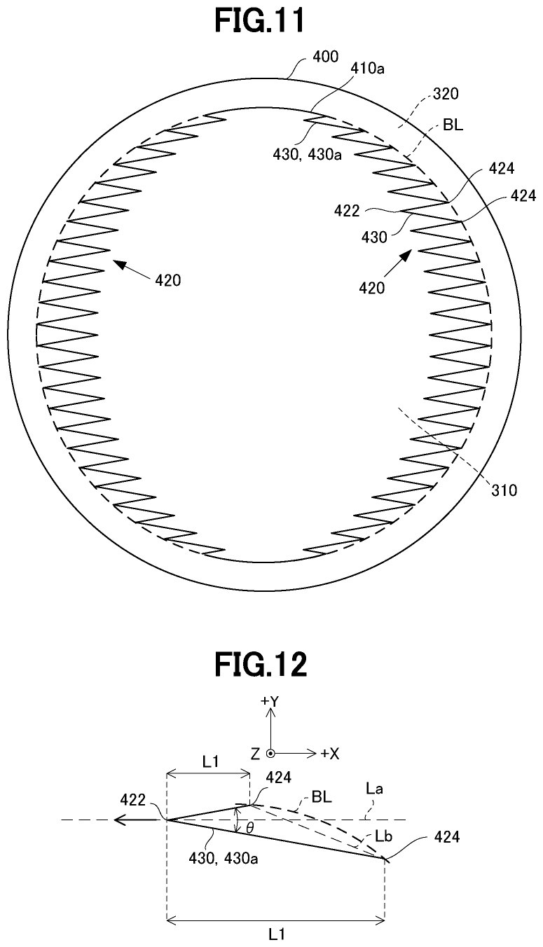

As illustrated in FIG. 11, as with the light shield 400 of Embodiment 1, the light shield 400 of the present embodiment overlaps the non-display region 320 of the decorative member 300 corresponding to the frame region 116 of the display 100 when viewed from above, and includes the serrated configurations 420 at the end portions 410a located on the display region 310 side of the decorative member 300. In the present embodiment, the serrated configurations 420 overlap the display region 310 when viewed from above, and as illustrated in FIGS. 11 and 12, the tip portions 430 of the serrated configurations 420 extend in the direction (X direction) parallel to the direction (X direction) in which the pattern of the decorative layer 304 extends. In order to facilitate comprehension, the decorative member 300 is illustrated by a dashed line in FIG. 11.

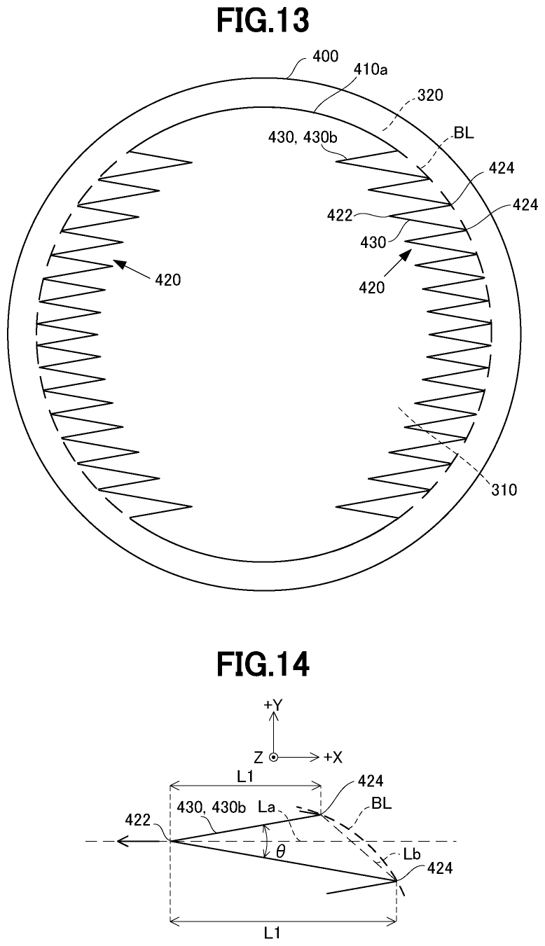

In the present embodiment, the displayable region 114 of the display 100 and the display region 310 of the decorative member 300 have a circular shape, and the serrated configurations 420 of the light shield 400 are thus arranged along the circumference of the display region 310 (the boundary BL) of the decorative member 300. When the serrated configurations 420 are arranged along the circumference, at the tip portions 430 (for example, a tip portion 430a) of the serrated configurations 420 located at the +Y-side end and the −Y-side end, one of two horizontal distances L1 in the direction in which the pattern of the decorative layer 304 extends, each horizontal distance L1 being between the root 424 and the tip 422 adjacent to the bottom 424 in the serrated configuration 420, becomes shorter (FIG. 12). Thus, the one horizontal distance L1 may deviate from the preferable length range (5 mm≤L1≤40 mm). Accordingly, as illustrated in FIGS. 13 and 14, a size of the tip portion 430 is preferably adjusted such that two horizontal distances L1 of the tip portion 430 (for example, a tip portion 430b) are within the preferable length range. In order to facilitate comprehension, the decorative member 300 is illustrated by a dashed line in FIG. 13.

As with the display device 10 of Embodiments 1 and 2, in the display device 10 of the present embodiment, the serrated configurations 420 at the end portions 410a of the light shield 400 overlap the display region 310 of the decorative member 300. The tip portions 430 of the serrated configurations 420 extend in the direction parallel to the direction in which the pattern of the decorative layer 304 extends. Therefore, in the display device 10 of the present embodiment, the boundary BL between the display region 310 and the non-display region 320 of the decorative member 300 can be less visible in the non-display state.

In FIGS. 11 and 12, even when one of the horizontal distances L1 deviates from the preferable length range, in the display device 10, the boundary BL between the display region 310 and the non-display region 320 of the decorative member 300 can be less visible in the non-display state.

### Modified Examples

The above embodiments may be modified in various manners within the gist of the present disclosure.

For example, the display 100 may include an organic electro-luminescence (EL) display panel or a micro LED display panel instead of the liquid crystal display panel 110 and the back light 120. The display 100 may be formed from a display panel alone.

In the embodiments, the decorative member 300 includes the light-transmitting film 302 and the decorative layer 304. The decorative member 300 may be formed from the decorative layer 304 alone. The decorative layer 304 may be formed directly on the first main surface 200a or the second main surface 200b of the cover 200.

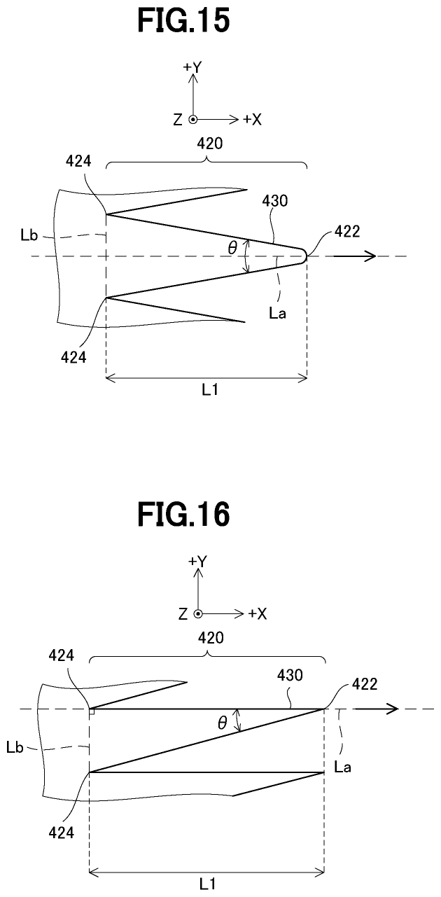

The tips 422 of the serrated configurations 420 of the light shield 400 may be rounded as illustrated in FIG. 15.

In the serrated configurations 420 of the light shield 400, the triangle (the tip portion 430) defined by one tip 422 and two roots 424 adjacent to the one tip 422 may be a right triangle as illustrated in FIG. 16.

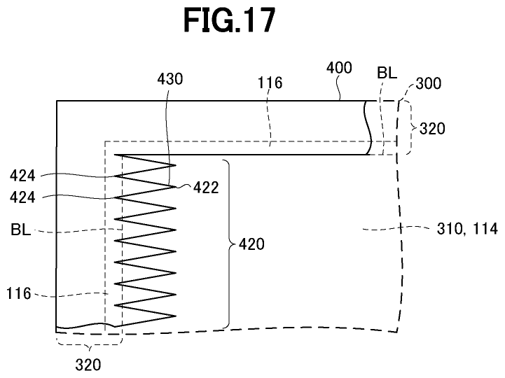

In the embodiments, the roots 424 of the serrated configurations 420 and the boundary BL overlap each other when viewed from above. As illustrated in FIG. 17, a configuration may be employed in which the roots 424 of the serrated configurations 420 and the boundary BL do not overlap each other when viewed from above.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display device comprising:
a display to display a screen element;
a cover disposed on a display surface side of the display and having a light-transmitting property;
a decorative member provided on a main surface of the cover, including a display region in which the screen element is transparently displayed and a non-display region adjacent to the display region, and having a pattern extending in a predetermined direction; and
a light shield disposed between the display and the decorative member and overlapping the non-display region when viewed from above, wherein the light shield includes a serrated configuration at an end portion located on the display region side when viewed from above,
at least a portion of the serrated configuration overlaps the display region when viewed from above, and
a direction in which a tip portion of the serrated configuration extends is parallel to a direction in which the pattern extends.

2. The display device according to claim 1, wherein
a horizontal distance in the direction in which the pattern extends, between a root and a tip adjacent to the root in the serrated configuration, is 5 mm or greater and 40 mm or less.

3. The display device according to claim 1, wherein
an angle of the tip portion is 10° or greater and 25° or less.

4. The display device according to claim 1, wherein
a root of the serrated configuration overlaps a boundary between the display region and the non-display region when viewed from above.

5. The display device according to claim 1, wherein the pattern is a woodgrain pattern or a hairline pattern.
